(19) United States
(12) Patent Application Publication
(10) Pub. No.: US 2016/0178123 A1
(43) Pub. Date: Jun. 23, 2016

(54) Machine Fluid Containment Trough

(71) Applicant: HalenHardy, LLC, Bellwood, PA (US)

(72) Inventors: Donald L. Beaver, Bellwood, PA (US); Dennis G. Middleton, Bellwood, PA (US); Terry Eugene Phillips, Bellefonte, PA (US); Joshua D. Beaver, Bellwood, CA (US); Brendon W. Guida, Bellwood, PA (US)

(21) Appl. No.: 14/978,496

(22) Filed: Dec. 22, 2015

Related U.S. Application Data
(60) Provisional application No. 62/157,029, filed on May 5, 2015.
(60) Provisional application No. 62/095,915, filed on Dec. 23, 2014.

(51) Int. Cl. F16N 31/00; B01D 17/02; B65D 25/24; B65D 1/34; B65D 25/16

(52) U.S. Cl. CPC F16N 31/006; B65D 1/34; B65D 25/16; B65D 25/24; B01D 17/0208

(57) ABSTRACT

A system for collecting machine fluid includes a frame having a first end, a second end, and a trough between the first and second ends. A mass of extendible fabric is positioned proximate to the first end of the frame and configured to be drawn across the trough to the second end. A holder secures a portion of the fabric proximate to the first end. The fabric may include a carrying structure such as a roll. The holder may include a rod to receive and secure the carrying roll. A sliding or fixed cutter may be positioned near the second end to cut the fabric. Alternatively, the fabric may be perforated and the second end may include a rigid support member across which the perforations may be pulled and torn.

### CROSS-REFERENCE TO RELATED APPLICATIONS

This application claims priority to U.S. Provisional Patent Application No. 62/095,915, filed Dec. 23, 2014, and U.S. Provisional Patent Application No. 62/157,029, filed May 5, 2015, both of which are incorporated herein by reference in their entireties.

### BACKGROUND

The present disclosure relates to a containment trough and system for collecting machine fluids from pump assemblies or other machinery used in various industrial processes, such as hydraulic fracturing and the like.

Conventional grease or oil overflow or catch trays for pump assemblies used in various industrial processes, such as hydraulic fracturing and the like, cause large messes and slipping hazards for workers. Each conventional grease or oil catch tray presently requires cleaning up to six to eight times per day and hence is labor intensive and time consuming to clean and maintain in the work environment. During operation of the pump assembly in various industrial processes (e.g., hydraulic fracturing), grease oozes between the pump end and the fluid end of the fracturing pump. A shallow conventional grease tray catches some grease while other grease seeps over the sides of the tray. The seeping grease creates a hazardous slippery walking or working surface for the worker in the work environment.

A further problem with conventional grease or oil trays is that they inadequately protect the ground beneath the pump assembly or other machinery thus leading to ground contamination or pollution. Much of the equipment used in various industrial processes is deployed in outdoor environments and exposed to various weather conditions. When precipitation occurs, the rain water intermingles with the grease residue remaining in the catch trays. Some of the hydrocarbons from the grease float to the top of the water and create water with an oily sheen. As precipitation continues, this water with an oily sheen runs out of the grease tray and onto the ground creating further ground contamination.

The present disclosure describes a containment trough and system directed to solving at least some of the problems described above.

### SUMMARY

In a first aspect, there is provided herein a system for collecting machine fluid expelled from a pump. The system includes a frame having a first end, a second end, and a trough that extends from the first end to the second end. The frame is configured to fit under a pump assembly and collect machine fluid that is expelled from the pump assembly. A mass of extendible fabric is positioned proximate to the first end of the frame and is configured to be drawn across the trough to the second end. A holder is configured to secure a portion of the mass of extendible fabric proximate to the first end.

In certain embodiments, the mass of extendible fabric includes a carrying roll and the holder includes a rod configured to receive and secure the carrying roll.

In certain embodiments, the carrying roll of extendible fabric may be configured with a cover to protect the extendible fabric from the elements.

In certain embodiments, the system further includes a sliding or fixed cutter positioned proximate to the second end, wherein the sliding or fixed cutter is configured to receive the extendible fabric and includes a knife that may be extended across the fabric to cut the fabric.

In certain embodiments, the system further includes a scraper positioned proximate to the second end and positioned to receive the fabric and remove the machine fluid from the fabric as the fabric is drawn across the scraper.

In certain embodiments, the system further includes a roller positioned proximate to the second end and beyond the scraper, wherein the roller is configured to receive the fabric after it has passed through the scraper and hold the fabric about a carrying roll.

In certain embodiments, the system further includes an oil-water separator positioned under the trough and configured to catch fluid that may flow out of the trough. The separator includes a base layer and a berm that collect portions of the fluid that include lubricant fluid while passing portions of the fluid that comprise water.

In certain embodiments, the trough is semi-circular and comprised of plastic, tarp, or metal.

In certain embodiments, the fabric comprises a textured surface.

In certain embodiments, the fabric comprises needle-punched polypropylene and/or a woven material or a combination of suitable woven materials.

In certain embodiments, the system further includes one or more hold-down arms positioned over the trough between the first end and the second end and configured to retain the fabric in the trough.

In certain embodiments, the system further includes a first and second longitudinal drip edge secured to a first outer side and a second outer side of the trough between the first end and the second end of the frame such that the drip edge serves as a guide for the extendible fabric.

In certain embodiments, the extendible fabric may be configured as a folded fabric, a dispenser of sheets, or as a perforated fabric at appropriate lengths.

In certain embodiments, the extendible fabric may be secured to the trough at the second end of the frame by a suitable securing mechanism.

In certain embodiments, the frame includes a plurality of foldable legs with corresponding joints such that the frame is collapsible for storage.

In certain embodiments, the plurality of foldable legs is articulated at each joint with a coated fabric material such as aluminum or fiberglass.

In certain embodiments, the frame includes a first side supporting member and a second side supporting member each connected to the trough such that the frame is configured to be hung from an upper supporting surface.

In a second aspect, there is provided herein a system for collecting machine fluid expelled from a pump. The system includes a frame having a first end, a second end, and a trough that extends from the first end to the second end. The frame further has a first side supporting member and a second side supporting member each connected to the trough such that the frame is configured to be hung from an upper supporting surface to enable the trough to collect machine fluid that is expelled from the pump assembly. A mass of extendible fabric is positioned proximate to the first end of the frame and is configured to be drawn across the trough to the second end. A holder is configured to be connected to the upper supporting surface and extends downwardly therefrom for securing a portion of the mass of extendible fabric proximate to the first end.

In certain embodiments, the frame is hung from the upper supporting surface by at least one or more connecting members.

In certain embodiments, the system further includes an oil-water separator positioned under the trough and configured to catch fluid that may flow out of the trough. The separator includes a base layer and a berm that collect portions of the fluid that include lubricant fluid while passing portions of the fluid that comprise water.

### BRIEF DESCRIPTION OF THE DRAWINGS

FIG. 1 is a front perspective view of a system for collecting machine fluid expelled from a pump in accordance with the present disclosure.

FIG. 2 is a perspective view of an alternate embodiment of a system for collecting machine fluid.

FIG. 3 is a sectional view of an example side support for a fluid collection system.

FIG. 4 illustrates an example of a carrying roll of a mass of extendible fabric in accordance with an embodiment of the present disclosure.

FIG. 5 is a perspective view of a sliding cutter configured to receive the extendible fabric and includes a knife that may be extended across the fabric to cut the fabric in accordance with the present disclosure.

FIG. 6 is a top perspective view of an oil-water separator that may be used with the system of the present disclosure.

FIG. 7 is a cross-sectional view of the oil-water separator of FIG. 6 that may be used with the system of the present disclosure.

FIG. 8 is partial sectional side view of an alternative oil-water separator that may be used with the system of the present disclosure.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. All sizes recited in this document are by way of example only, and the disclosure is not limited to structures having the specific sizes or dimensions recited below. As used in this document, the term “comprising” means “including, but not limited to.”

In consideration of the figures, it is to be understood for purposes of clarity certain details of construction and/or operation are not provided in view of such details being conventional and well within the skill of the art upon disclosure of the document described herein.

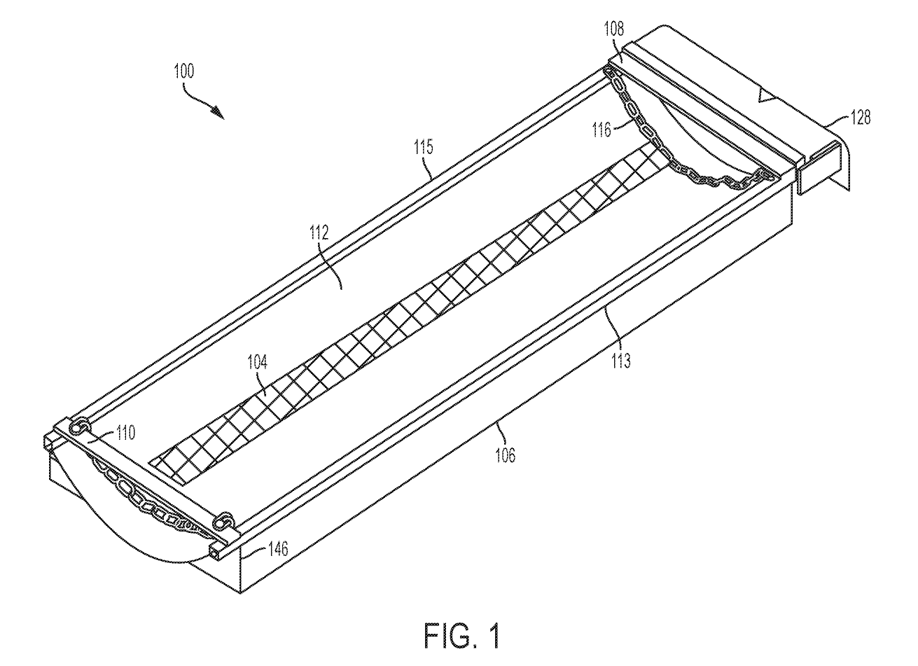

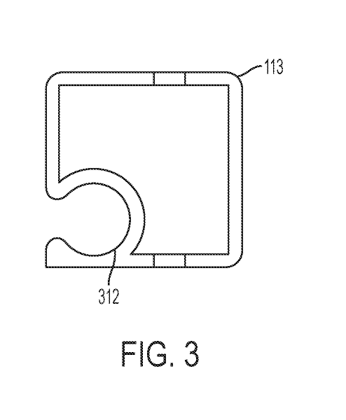

FIG. 1 is a front perspective view of a system 100 for collecting machine fluid expelled from a pump. The system 100 fits under a pump and includes a frame 106 comprising a first end 108, a second end 110, a first side support member 113, a second side support member 115 and a trough 112 that extends from the first end 108 to the second end 110. The trough 112 is connected to and supported by the side support members 113 and 115 so that the trough 112 hangs from the side support members. As shown, the trough may include side cavities that slip over the side support members 113 and 115, although other configurations that connect the trough to the side support members are possible. The first end 108 and second end 110 of the frame 106 may be open as shown, or the ends may include additional supporting members. For example, as shown in FIG. 3, the side support members may include cavities 312 that receive a portion of the trough, such as a rolled fabric portion or an additional side supporting member that is attached to an edge of the trough. The first end 108 and second end 110 of the frame may be open, or the ends may include additional supporting members as shown in FIG. 1. Optionally, the trough may include a central area with a screen through which liquids may pass. A roll or other mass of extendible fabric (shown under a housing 128) may be pulled through the trough 112 from the first end 108 to the second end 110.

The frame is configured to fit under a pump assembly and collect machine fluid that is expelled from the pump assembly. Returning to FIG. 1, the mass of extendible fabric is positioned proximate to the first end 108 of the trough 112 and is configured to be drawn across the trough 112 to the second end 110. A holder 116 is configured to secure a portion of the mass of extendible fabric 114 proximate to the first end 108

As shown, the frame also includes a frame 106 that supports the side support members 113, 115 and from which the holder 116 upwardly extends. The frame may include one or more legs 146, which may be rigid or collapsible. For example, each leg may include an articulating joint and/or a telescoping structure so that the device may be collapsed for storage.

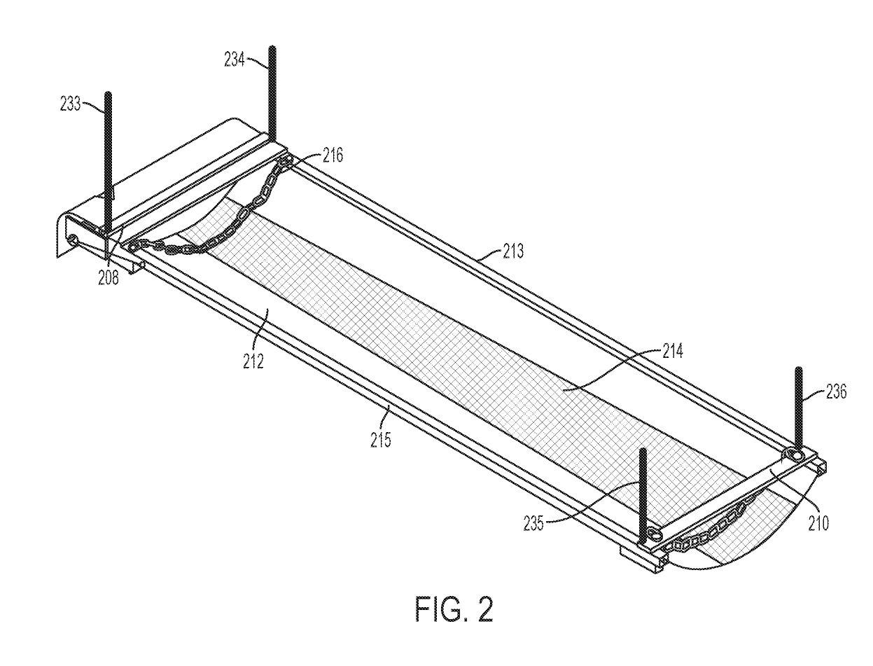

In embodiments such as that shown in FIG. 1, the frame may be set on a level surface such that when the trough fills with machine fluid the used fabric is removed and new fabric is dispensed, unfolded, or rolled out. In other embodiments, such as that shown in FIG. 2, the frame may hang from an upper supporting structure. In this embodiment, the frame may omit the base and may be configured so that the side support members 213, 215, the holder 216, or both hang from an upper support by members that extend downward from the upper support, such as one or more chains, downwardly extending support bars, zip ties, magnets, bolts and/or other structures. An example of this is shown in FIG. 2, where the trough 212 and side supports 213, 215 hang from an upper supporting frame via supporting members 233-236 such as cables, wires or chains. The frame may attach to an upper supporting structure, such as the pump itself, via one or more connecting members such as clamps, brackets, bolts and the like. FIG. 2 also shows how the extendible fabric 214 may be pulled through the trough 212 from the first end 208 to the second end 210. Such a configuration also may apply to the embodiment of FIG. 1, along with other embodiments

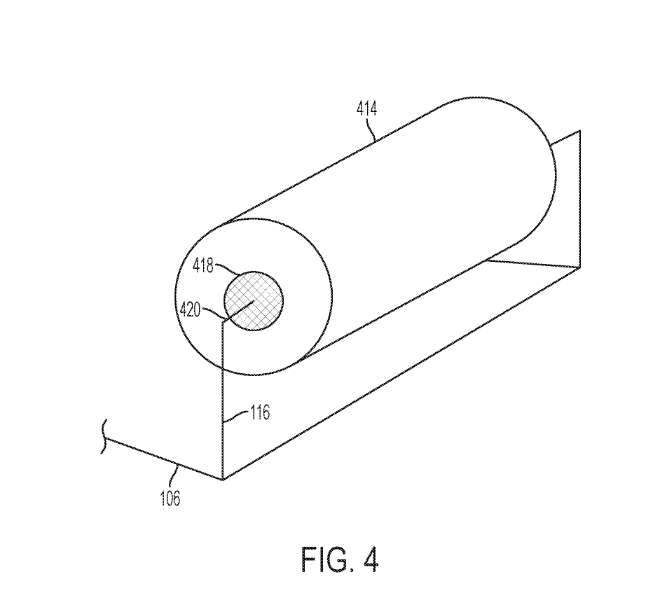

FIG. 4 is an up close side perspective view of a carrying roll 418 of a mass of extendible fabric 414 in accordance with an embodiment of the present disclosure. The holder 116 extends from the base 106 and includes a rod 420 configured to receive and secure the carrying roll 418. In some embodiments, the carrying roll 418 and fabric 414 may be configured with a cover (e.g., 128 in FIG. 1) to protect the extendible fabric from the elements. Other configurations are possible. For example, the holder 116 may be a dispenser from which the fabric is dispensed in a folded or pleated form, in sheets, or in other configurations.

FIGS. 1 and 2 both show a fabric guide member or hold down member 116, 216 positioned over the trough 112, 212. Any number of such members may be used and positioned in various locations between the first end and the second end and configured to retain the fabric in the trough. It should be understood that the fabric guide members may be fabricated of any suitable material, shape, and size, such as chains, bars, or other structures.

It is also contemplated in accordance with some embodiments that the fabric may be temporarily secured to the trough 112 at the second end 110 of the frame 106 by a suitable securing mechanism, such as Velcro®, push tabs, drop chain, and the like.

In some embodiments, the trough 112 is semi-circular or arc-shaped and comprised of plastic, tarp, or metal. For example, the trough may be made of any woven or non-woven fabric suitable for carrying heavy grease and other viscous materials. Example trough materials also include PET, polyethylene, polypropylene and other thermoplastics that are spun bond, spun laced, needle punched or otherwise formed. In one embodiment, the trough 112 is fabricated of a 40 ounce coated fabric tarp. Other materials may be used. It should be understood that the trough may be fabricated of any suitable shape designed to fit underneath the pump assembly and any suitable material durable enough to contain the seeping machine fluid during operation of the industrial process, such as hydraulic fracturing.

It should be understood that the dimensions of the trough and fabric may vary based on the available space under the pump or other machinery. In some applications, the trough may be about 18 inches wide. For example, in some embodiments, the trough may be 18 inches wide by 52 inches long and 18 inches wide by 64 inches long. Optionally, although not a requirement, the trough may be configured such that there is no more than 20 pounds of grease or fluid in the trough at any one time to ensure ease of removal of the used fabric from the trough by a worker.

In some embodiments, the frame may be set on a level surface such that when the trough fills with machine fluid the used fabric is removed and new fabric is dispensed, unfolded, or rolled out. In other embodiments, the frame may hang from an upper supporting structure.

In some embodiments, the fabric includes a textured surface that provides friction so that the machine fluid, such as grease, oil, or other lubricant, does not easily slip around. In some embodiments, the fabric may be formed of needle-punched polypropylene and/or a woven material or a combination of suitable woven materials. For example, the fabric may be formed of a woven, needle-punched polypropylene such as that used in weed block fabrics. It should be understood that the fabric may be fabricated of any suitable textured surface for use with the system of the present disclosure.

In further embodiments, the extendible fabric may be configured as a folded fabric, a dispenser of sheets, or as a perforated fabric at appropriate lengths. If the fabric is configured as a perforated roll, a cutter is not necessary for use with the system.

In one optional embodiment of the present disclosure, the frame includes a plurality of foldable legs with corresponding joints such that the frame is collapsible for convenient storage. One or more of the plurality of foldable legs may include an articulating joint with a coated fabric material such as aluminum or fiberglass or the like.

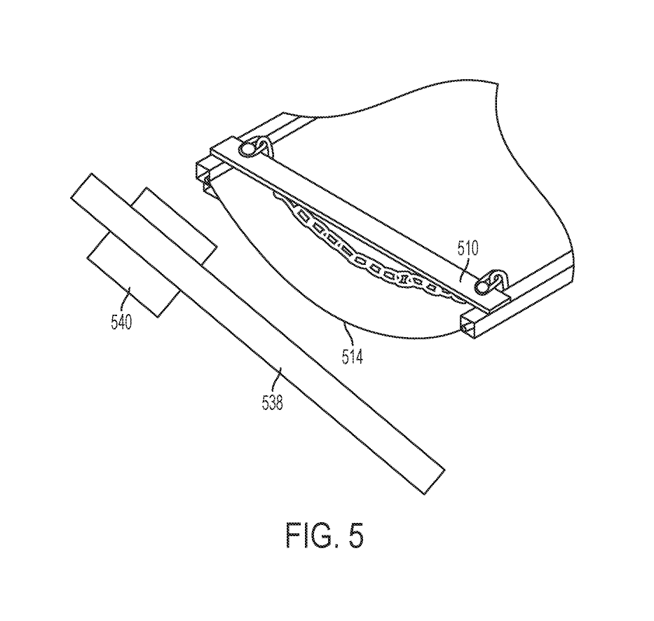

Referring now to FIG. 5 is a perspective view of a sliding cutter 538 positioned proximate to the second end 110 and configured to receive the extendible fabric 514. The sliding cutter 538 includes a knife 540 that may be extended across the fabric 514 to cut the fabric in accordance with the present disclosure. It should be understood that sliding cutter 538 may also be configured as a fixed cutter having a knife positioned proximate to the second end 510 and configured to receive the extendible fabric 514. Alternatively, the fabric may be formed of perforated sheets, and in such cases a cutter may not be needed, or the second end may simply include a rigid support member across which the perforations may be pulled and torn.

In some embodiments, the system includes a scraper (not shown) positioned proximate to the second end and positioned to receive the fabric and remove the machine fluid from the fabric as the fabric is drawn across the scraper. It should be understood that the scraper can be fabricated of any suitable material, shape, and size, in accordance with the system 100 of the present disclosure.

In further embodiments, the system includes a roller positioned proximate to the second end and beyond the scraper, wherein the roller is configured to receive the fabric after it has passed through the scraper and hold the fabric about a receiving roll. It should be understood that the roller can be fabricated of any suitable material, shape, and size, in accordance with the system of the present disclosure. The used fabric rolled about the receiving roll can be appropriately cleaned with detergent and washed for re-use or recycling.

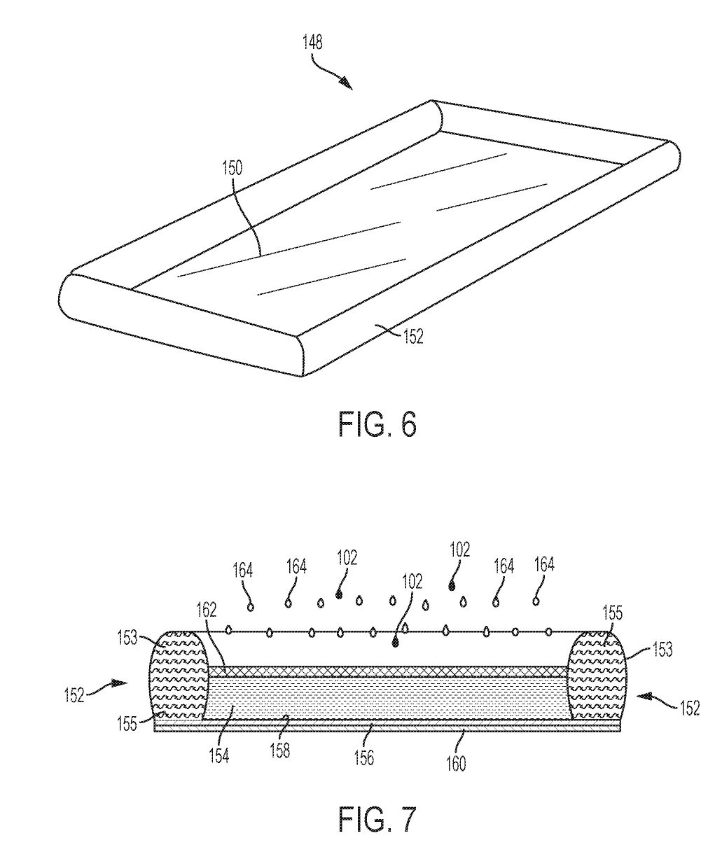

FIG. 6 is a top perspective view of an oil-water separator 148 that may be used with the system of the present disclosure. Reviewing FIGS. 6 and 1 together, the oil-water separator 148 may be positioned under the second end 110 of the trough 112 to receive fluids that fall from the trough 112. Alternatively, the entire trough 112 may be positioned over the oil-water separator 148 so that the separator collects fluids that fall through the trough's screen. In one embodiment, the oil-water separator 148 includes a substantially flat collection surface 150 formed with a wall or berm 152 around its perimeter. The oil-water separator 148 may be of any suitable shape and size to fit the configuration of the machinery or pump underneath which it is used. Referring to FIG. 7, the berm 152 may be configured as a fabric tubular structure 153 containing polypropylene fiber material 155 to ensure sufficient rigidity as a self-supporting structure in use. The height of the berm 152 may be generally about 1.97 inches to about 3.94 inches, although other sizes are possible. The berm 152 may be formed with a flattened base 160 so that it may be attached to the periphery of the collection surface 150.

The collection surface 150 may be formed of an impermeable base layer 156 made of plastic, vinyl, polyethylene, urethane-coated polyester or canvas, or other material on which a permeable fabric layer 158 retains a layer of fibrous polypropylene material. The fabric layer may be a water- and oil-permeable plastic woven or non-woven textile material and such same material is suitable for use in forming the fabric tubular structure of the berm 152.

In some embodiments, the berm 152 may be formed of a core, with an oleophilic material wrapped around the core and a permeable supporting fabric (such as netting) formed around the oleophilic material to retain the oleophilic material in place. The core may be made of an open cell foam that allows water to pass through, such as quantum foam, polyurethane foam or foam rubber, extruded polystyrene (XPS) foams, phenolic foam and the like. In other embodiments, the berm 152 may be formed of alternating layers of oleophilic material and supporting material, rolled about a central axis. The central axis may be a foam core, or it may simply be an end of one or both of the layers of material.

FIG. 7 is a cross-sectional view of an oil-water separator of FIG. 6 that may be used with the system of the present disclosure. In operation, the base 106 and/or frame may be positioned on top of the collection surface (156 and 158) and inside the oil-water separator 148. In embodiments where the frame hangs from an upper surface, the oil-water separator may be positioned under the trough 112. Excess or leaky machine fluid or oil (shown as black drops 102) falls into the oil-water separator underneath the trough, which in turn is directly underneath the machinery. An oil layer 162 is formed on the collection surface, and in the case of rainfall (shown as white drops 164), water 154 may accumulate in the oil-water separator 148 underneath the oil layer 162. The liquids flow into the berm 152 where the oil 102 is attracted to and retained by the polypropylene fibers or suitable oleophilic materials, while the water is repelled by the hydrophobic fibers and exits from the walls and drains away. Oil 102 is absorbed by the fibrous material in the collection surface 150 (158+156) and/or berm 152 and remains there.

The machine fluid or oil saturated collection surface 150 may be regenerated by passing the collection surface, or the entire oil-water separator, between rollers. Machine fluid is then collected and disposed. The oil-water separator may be mechanically squeezed, centrifuged, dry cleaned with mineral spirits or washed with detergent and water to remove any residual machine fluid and to ready it for re-use.

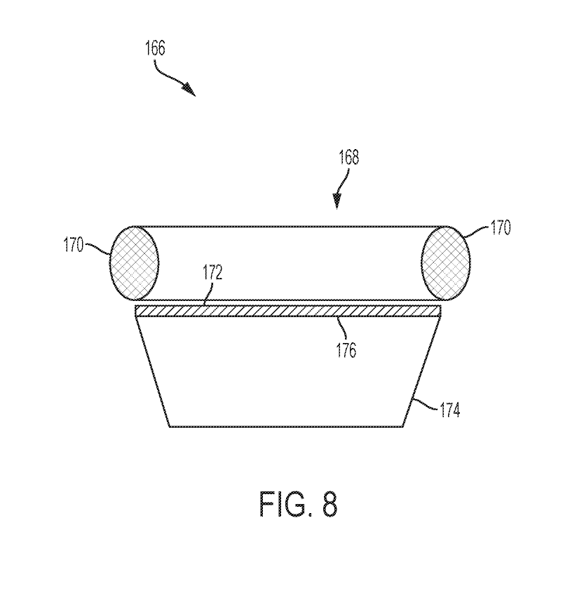

FIG. 8 is partial sectional side view of an alternative oil-water separator 166 that may be used with the system 100 of the present disclosure. Oil-water separator 166 is configured similarly as the oil-water separator 148 of FIGS. 6-7 having a geometrically shaped flat surface 168 formed with a wall 170 around its perimeter. The flat surface 168 is formed of a base layer 172 having a layer of an oil permeable hydrophobic material and the wall 170 having a layer of water permeable oleophilic material in which machine fluid 102 falling on the flat surface 168 passes through the base layer and water falling on the flat surface 168 exits through the wall 170. This embodiment of the oil-water separator 166 further includes a portable collector for machine fluids including an open tank 174, a mesh plate 176 positioned on top of the open tank 174, and a flat surface 168 with a wall 170 as described above positioned on the mesh plate 176. In operation, the frame and some portions, or all of, the trough 112 are positioned over the oil-water separator 166 and directly underneath the machinery or pump 104.

In some embodiments, the oil permeable material forming the base layer 172 includes a felt material with a fabric cover. The felt material may be fabricated of any suitable oil permeable material, including oleophilic/hydrophobic polytetrafluoroethylene (PTFE) fibers. The oleophilic material forming the walls 170 may be fabricated of fibers of an oily plastic material, such as polyolefin. The hydrophobic fibers may be formed from suitable polymers set forth above or as a fiber coating, by plasma deposition, surface modification, or by a sol-gel process.

The features and functions described above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for collecting machine fluid expelled from a pump, comprising:
a frame comprising a first end, a second end, and a trough that extends from the first end to the second end, wherein the frame is configured to fit under a pump assembly so that the trough will collect machine fluid that is expelled from the pump assembly;
a mass of extendible fabric positioned proximate to the first end of the frame and configured to be drawn across the trough to the second end; and
a holder for securing a portion of the mass of extendible fabric proximate to the first end.

2. The system of claim 1, wherein
the mass of extendible fabric comprises a carrying roll; and
the holder comprises a rod configured to receive and secure the carrying roll.

3. The system of claim 2, wherein the carrying roll of extendible fabric is configured with a cover to protect the extendible fabric from the elements.

4. The system of claim 1, further comprising:
a sliding or fixed cutter positioned proximate to the second end, wherein the sliding or fixed cutter is configured to receive the extendible fabric and includes a knife that may be extended across the fabric to cut the fabric.

5. The system of claim 1, further comprising:
a scraper positioned proximate to the second end and positioned to receive the fabric and remove the machine fluid from the fabric as the fabric is drawn across the scraper.

6. The system of claim 5, further comprising:
a roller positioned proximate to the second end and beyond the scraper, wherein the roller is configured to receive the fabric after it has passed through the scraper and hold the fabric about a carrying roll.

7. The system of claim 1, further comprising:
an oil-water separator positioned under the trough and configured to catch fluid that may flow out of the trough, wherein the oil-water separator comprises a base layer and a berm that collect portions of the fluid that comprise lubricant fluid while passing portions of the fluid that comprise water.

8. The system of claim 1, wherein the trough is semi-circular and comprised of plastic, tarp, or metal.

9. The system of claim 1, wherein the fabric comprises a textured surface.

10. The system of claim 1, wherein the fabric comprises needle-punched polypropylene, a woven material, or a combination of woven materials.

11. The system of claim 1, further comprising one or more hold-down arms positioned over the trough between the first end and the second end and configured to retain the fabric in the trough.

12. The system of claim 1, further comprising a first and second longitudinal drip edge secured to a first outer side and a second outer side of the trough between the first end and the second end of the frame, wherein the drip edge serves as a guide for the extendible fabric.

13. The system of claim 1, wherein the extendible fabric is configured as a folded fabric, a dispenser of sheets, or as a perforated fabric.

14. The system of claim 1, wherein the extendible fabric is secured to the trough at the second end of the frame by a suitable securing mechanism.

15. The system of claim 1, wherein the frame comprises a plurality of foldable legs with corresponding joints such that the frame is collapsible for storage.

16. The system of claim 15, wherein the plurality of foldable legs is articulated at each joint with a coated fabric material comprising aluminum or fiberglass.

17. The system of claim 1, wherein the frame comprises a first side supporting member and a second side supporting member each connected to the trough such that the frame is configured to be hung from an upper supporting surface.

18. A system for collecting machine fluid expelled from a pump, comprising:
a frame comprising a first end, a second end, and a trough that extends from the first end to the second end, the frame further comprising a first side supporting member and a second side supporting member each connected to the trough such that the frame is configured to be hung from an upper supporting surface to enable the trough to collect machine fluid that is expelled from the pump assembly;
a mass of extendible fabric positioned proximate to the first end of the frame and configured to be drawn across the trough to the second end; and
a holder connected to the upper supporting surface and extending downwardly therefrom for securing a portion of the mass of extendible fabric proximate to the first end.

19. The system of claim 18, wherein the frame is hung from the upper supporting surface by at least one or more connecting members.

20. The system of claim 18, further comprising:
an oil-water separator positioned under the trough and configured to catch fluid that may flow out of the trough, wherein the oil-water separator comprises a base layer and a berm that collect portions of the fluid that comprise lubricant fluid while passing portions of the fluid that comprise water.
